(19) United States
(12) Patent Application Publication
(10) Pub. No.: US 2023/0094720 A1
(43) Pub. Date: Mar. 30, 2023

(54) Computer-Implemented Objective Performance Evaluation for Software Design, Development , and Quality Assurance

(71) Applicant: International Business Machines Corporation, Armonk, NY (US)

(72) Inventors: Suresh Kumar Ramu, Bangalore (IN); Sajesh Sudhakaran, Bangalore (IN); Sivaraj Sethunamasivayam, Bangalore (IN); Sandeep Sreerama, Bengaluru (IN)

(21) Appl. No.: 17/487,603

(22) Filed: Sep. 28, 2021

(51) Int. Cl. G06Q 10/06; G06F 8/70; G06F 8/10

(52) U.S. Cl. CPC G06Q 10/063112; G06Q 10/06393; G06Q 10/06398; G06F 8/70; G06F 8/10

(57) ABSTRACT

An objective performance evaluation engine collects one or more requirements from a customer and developing functional design specifications and creates a set of sub-tasks and assigning the sub-tasks to individual developers. Each developer implements code changes required for the sub-task and delivers the code changes with comments into a code repository. The objective performance evaluation engine generates an implementation benchmark ownership data structure for the code changes and calculates positive impact on performance evaluation based on a comparison of actual effort to implement the code changes versus estimated effort for the sub-task. Responsive to quality assurance detecting a defect in the code changes, the objective performance evaluation engine identifies an owner of the defect by looking up in the implementation benchmark ownership data structure and calculates negative impact on performance evaluation based on a severity of the defect.

### BACKGROUND

The present application relates generally to an improved data processing apparatus and method and more specifically to mechanisms for objective performance evaluation for software design, development, and quality assurance.

Software development is the process of conceiving, specifying, designing, programming, documenting, testing, and bug fixing involved in creating and maintaining applications, frameworks, or other software components. Software development is a process of writing and maintaining the source code, but in a broader sense, it includes all that is involved between the conception of the desired software through to the final manifestation of the software, sometimes in a planned and structured process. Therefore, software development may include research, new development, prototyping, modification, reuse, re-engineering, maintenance, or any other activities that result in software products.

Software can be developed for a variety of purposes, the three most common being to meet specific needs of a specific client/business, to meet a perceived need of some set of potential users, or for personal use. The need for better quality control of the software development process has given rise to the discipline of software engineering, which aims to apply the systematic approach exemplified in the engineering paradigm to the process of software development. There are many approaches to software project management, known as software development life cycle models, methodologies, processes, or models.

A business analyst (BA) is a person who analyzes and documents the market environment, processes, or systems of businesses. They help businesses improve their processes, products, services, and software through data analysis and software. However, business analysts do not necessarily require programming skills. A computer programmer, sometimes called a software developer, is a person who creates computer software, i.e., computer code. The term software developer can refer to a specialist in one area of computers or to a generalist who writes code for many kinds of software. Quality assurance (QA) is a way of preventing mistakes and defects in software products and avoiding problems when delivering products or services to customers. Quality assurance comprises administrative and procedural activities implemented in a quality system so that requirements and goals for a product, service, or activity will be fulfilled. It is the systematic measurement, comparison with a standard, monitoring of processes, and an associated feedback loop that confers error prevention. User acceptance testing (UAT) consists of a process of verifying that a solution works for the user. It is not system testing (ensuring software does not crash and meets documented requirements) but rather ensures that the solution will work for the user (i.e., tests that the user accepts the solution).

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided in a data processing system comprising at least one processor and at least one memory, the at least one memory comprising instructions executed by the at least one processor to cause the at least one processor to implement an objective performance evaluation engine. The method comprises collecting, by the objective performance evaluation engine, one or more requirements from a customer and developing functional design specifications, wherein the functional design specifications are delivered by the business team as part of a task. The method further comprises creating, by the objective performance evaluation engine, a set of sub-tasks based on the functional design specifications and assigning the sub-tasks to individual developers, wherein each developer implements code changes required for the sub-task and delivers the code changes with comments into a code repository. The method further comprises generating, by the objective performance evaluation engine, an implementation benchmark ownership data structure for the code changes. The method further comprises calculating, by the objective performance evaluation engine, positive impact on performance evaluation based on a comparison of actual effort to implement the code changes versus estimated effort for the sub-task. The method further comprises identifying, by the objective performance evaluation engine, an owner of the defect by looking up in the implementation benchmark ownership data structure responsive to quality assurance detecting a defect in the code changes. The method further comprises calculating, by the objective performance evaluation engine, negative impact on performance evaluation based on a severity of the defect.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 is a sequence diagram depicting a flow of how a deliverable is designed in the business phase, built in the development phase, and tested in the quality assurance phase in accordance with an illustrative embodiment;

FIGS. 4A-4D are system context diagrams for demonstrating objective evaluation of performance in accordance with an illustrative embodiment;

FIG. 5 illustrates identifying a business analyst defect owner in accordance with an illustrative embodiment;

FIG. 6 illustrates identifying a developer defect owner in accordance with an illustrative embodiment;

FIG. 7 illustrates identifying a quality assurance defect owner in accordance with an illustrative embodiment;

FIG. 8 illustrates derivation of normalized effort demand baseline for developers in accordance with an illustrative embodiment; and

FIG. 9 illustrates an algorithm to calculate degree of complexity in accordance with an illustrative embodiment.

### DETAILED DESCRIPTION

Performance evaluation is an integral part of an employee's career. Employees in an Information Technology or software engineering background contribute to assigned projects over a period of an appraisal year. There are a variety of employee groups who come together to execute a project successfully. A majority of the employee groups are comprised of ground-level staff whose contributions can be seen in artifacts/documents in which they work. In today's real-time world, evaluating performance of an employee is a subjective matter, because performance evaluations are typically based on feedback or impressions accumulated over time. Also, it is normal to have staff and managers working in different locations, forcing the evaluation to be based on feedback from line leads or intermediate managers.

When performance evaluations are performed by human manager, the performance evaluations can be influenced by various factors. Personal rapport built by the employee with intermediate supervisors can have a positive impact on feedback and, thus, performance evaluations. A strong articulation skill of the employee can showcase the quality of work in an exaggerated manner, which will positively influence a performance evaluation. It is possible for a supervisor to overlook contributions by a given employee, which will have a negative influence on a performance evaluation. A supervisor can have a negative impression from a given project, which may taint the feedback that contributes to a performance evaluation.

The illustrative embodiments provide a computer-implemented mechanism for evaluating performance of an employee objectively and for quantifying the quality of a deliverable. The illustrative embodiments solve the problems associated with employee performance evaluations by evaluating an employee's relative performance based on the quality of product design and software code. The illustrative embodiments determine the benchmark ownership to denote sole ownership of each design specification, implementation, or defect raised. Based on proportional contribution based on a comparison of actual effort spent to estimated effort, the illustrative embodiments calculate positive impact, which is a metric (points) to denote intensity of contribution made to the task or sub-task. The illustrative embodiments also determine negative impact based on defect ownership. The illustrative embodiments then generate a performance evaluation based on the impact of the business analyst, developer, or quality assurance specialist in a manner that is not subject to human bias or personal influence.

Before beginning the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software executing on computer hardware, specialized computer hardware and/or firmware, or any combination thereof that performs the specified functions including, but not limited to, any use of a general and/or specialized processor in combination with appropriate software loaded or stored in a machine readable memory and executed by the processor to thereby specifically configure the processor to perform the specific functions of the illustrative embodiments. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

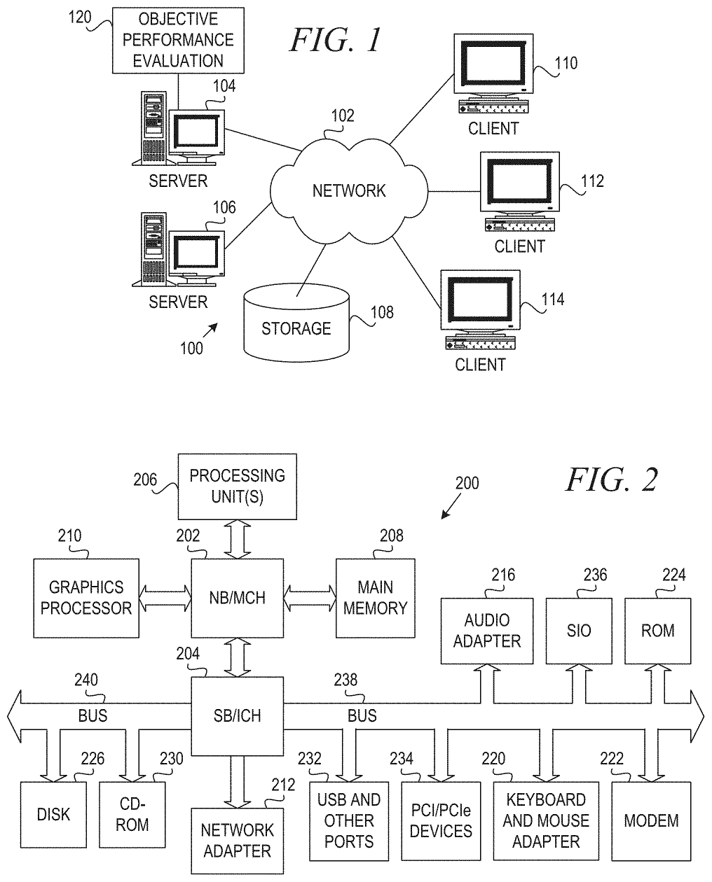

The illustrative embodiments may be utilized in many different types of data processing environments. To provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

As shown in FIG. 1, one or more of the computing devices, e.g., server 104, may be specifically configured to implement a system for objective performance evaluation for software design, development, and quality assurance. The configuring of the computing device may comprise the providing of application specific hardware, firmware, or the like to facilitate the performance of the operations and generation of the outputs described herein regarding the illustrative embodiments. The configuring of the computing device may also, or alternatively, comprise the providing of software applications stored in one or more storage devices and loaded into memory of a computing device, such as server 104, for causing one or more hardware processors of the computing device to execute the software applications that configure the processors to perform the operations and generate the outputs described herein regarding the illustrative embodiments. Moreover, any combination of application specific hardware, firmware, software applications executed on hardware, or the like, may be used without departing from the spirit and scope of the illustrative embodiments.

The illustrative embodiments provide a computer-implemented objective performance evaluation engine 120 for evaluating performance of an employee objectively and for quantifying the quality of a deliverable. The objective performance evaluation engine 120 solve the problems associated with employee performance evaluations by evaluating an employee's relative performance based on the quality of product design and software code. The objective performance evaluation engine 120 determines the benchmark ownership to denote sole ownership of each design specification, implementation, or defect raised. Based on proportional contribution based on a comparison of actual effort spent to estimated effort, the objective performance evaluation engine 120 calculates positive impact, which is a metric (points) to denote intensity of contribution made to the task or sub-task. The objective performance evaluation engine 120 also determines negative impact based on defect ownership. The objective performance evaluation engine 120 then generates a performance evaluation based on the impact of the business analyst, developer, or quality assurance specialist in a manner that is not subject to human bias or personal influence.

It should be appreciated that once the computing device is configured in one of these ways, the computing device becomes a specialized computing device specifically configured to implement the mechanisms of the illustrative embodiments and is not a general-purpose computing device. Moreover, as described hereafter, the implementation of the mechanisms of the illustrative embodiments improves the functionality of the computing device and provides a useful and concrete result that facilitates objective performance evaluation for software design, development, and quality assurance.

As noted above, the mechanisms of the illustrative embodiments utilize specifically configured computing devices, or data processing systems, to perform the operations for objective performance evaluation. These computing devices, or data processing systems, may comprise various hardware elements which are specifically configured, either through hardware configuration, software configuration, or a combination of hardware and software configuration, to implement one or more of the systems/subsystems described herein. FIG. 2 is a block diagram of just one example data processing system in which aspects of the illustrative embodiments may be implemented. Data processing system 200 is an example of a computer, such as server 104 in FIG. 1, in which computer usable code or instructions implementing the processes and aspects of the illustrative embodiments of the present invention may be located and/or executed so as to achieve the operation, output, and external effects of the illustrative embodiments as described herein.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCl/PCIe devices 234 connect to SB/ICH 204 through bus 238 and bus 240. PCl/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. In a client device, the operating system may be a commercially available operating system such as Microsoft® Windows 10®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® computer system, Power™ processor-based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

As mentioned above, in some illustrative embodiments the objective performance evaluation engine may be implemented as application specific hardware, firmware, or the like, application software stored in a storage device, such as HDD 226 and loaded into memory, such as main memory 208, for executed by one or more hardware processors, such as processing unit 206, or the like. As such, the computing device shown in FIG. 2 becomes specifically configured to implement the objective performance evaluation engine and specifically configured to perform the operations and generate the outputs described hereafter with regard to the objective performance evaluation for software design, development, and quality assurance.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

A typical project is executed by providing features or fixes as part of multiple releases. Based on need, a project may have multiple releases within a single calendar year or appraisal year. Each release typically comprises multiple “tasks” created by the business team based on the nature of functional elements. Once the tasks are in place, the development lead breaks the tasks down into multiple sub-tasks and assigns the sub-tasks to individual developers for implementation.

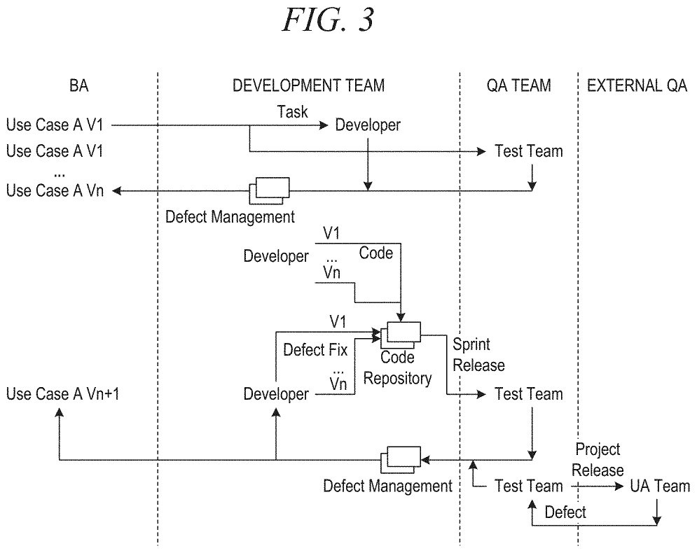

FIG. 3 is a sequence diagram depicting a flow of how a deliverable is designed in the business phase, built in the development phase, and tested in the quality assurance phase in accordance with an illustrative embodiment. The business analyst (BA) designs a project, Use Case A, in multiple versions V1, V2, . . . , Vn. The BA sends a task to the development team and to the test team. The test team tests the design for defects. If a defect is detected, then the defect is sent from the test team to defect management and then to the BA.

The developer generates code in versions V1, V2, . . . , Vn, which is stored in a code repository. The code is released as a sprint release, which is released to quality assurance (QA) for testing. A sprint is a short period of time wherein a development team works to complete specific tasks, milestones, or deliverables. Sprints, also referred to as “iterations,” essentially break a project schedule into digestible blocks of time in which smaller goals can be accomplished. The test team tests the code for defects. If a defect is detected, then the defect is sent from the test team to defect management and then to the BA and the developer.

The test team may also release the project to external QA, where a user acceptance testing team tests the project release. If a defect is detected by the UAT team, then the defect is sent to the test team and then on to defect management.

The quality of a business analyst can be adjudicated based on the limited number of functional design changes made after the design cut-off date. The quality of a developer can be adjudicated based on the limited number changes made on top of an initial baseline version after the development cut-off date for each defect raised by QA. The quality of a QA can be adjudicated based on the limited number of defects escaped to higher test environments, like UAT, after the QA cut-off date.

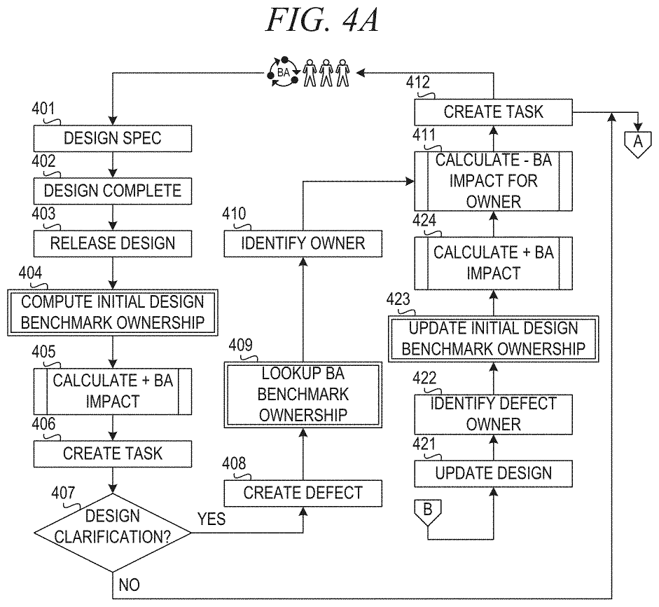

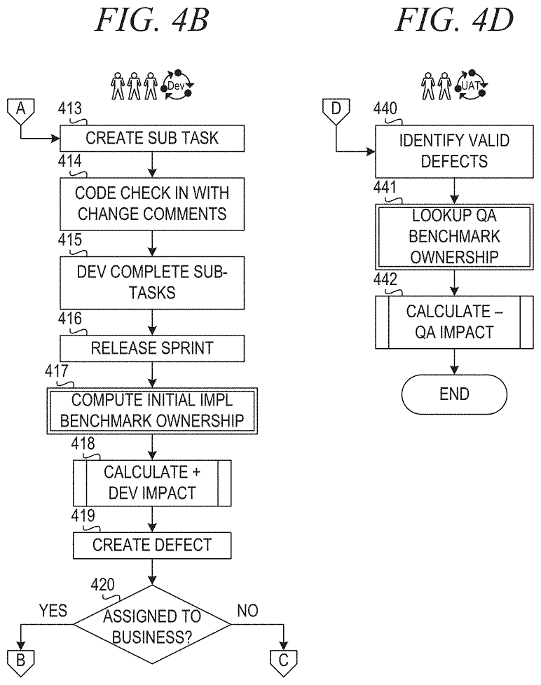

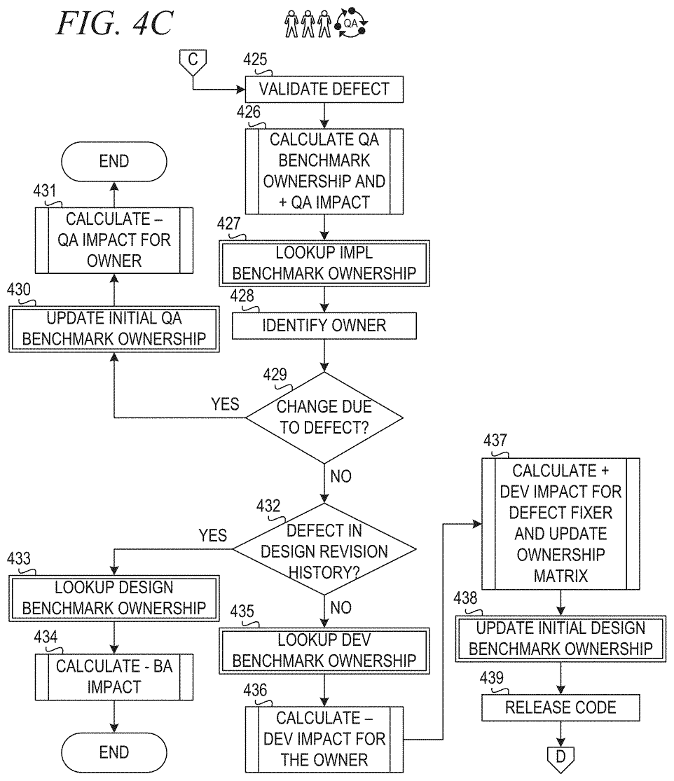

FIGS. 4A-4D are system context diagrams for demonstrating objective evaluation of performance in accordance with an illustrative embodiment. Beginning in FIG. 4A, a business team collects requirements from the customer and develops functional design specifications (block 401). The business team completes the requirements/functional specifications as part of a task created with an estimate in place (block 402). The collected design specifications are released to development team and QA team after completing the iterative internal review (block 403).

At this point, the objective performance evaluation engine of the illustrative embodiment computes the “design benchmark ownership” to denote the sole ownership of each design specification (block 404). This can be a Business Rules, Alternate Path step, screen attribute specifications, etc. Then, the objective performance evaluation engine composes matrix of “design owner” to “design specification unit.” Based on the proportional contribution to the design document based on actual effort spent versus the estimate, the objective performance evaluation engine calculates positive BA impact (block 405). This is a quantification metric (points) to denote the intensity of contribution made to the design at each business analyst level.

Once the design is formally released and the BA team creates a task (block 406), the development team and QA team simultaneously go through the design specifications to determine if there are any questions/clarifications (block 407). Any clarification which leads to a gap in design specification is considered a defect to the business/design team. If there are design clarifications, then the objective performance evaluation engine creates a defect (block 408). The objective performance evaluation engine looks up the “design benchmark ownership” matrix (block 409) and identifies the design owner (block 410).

Next, the objective performance evaluation engine calculates negative BA impact for the respective owner based on effort needed to incorporate the change in design (block 411). The objective performance evaluation engine then creates a task (block 412), which is returned to the BA team. Thereafter, or if the development team is good to go with the design specification, operation proceeds to FIG. 4B for processing related to the development team.

Turning to FIG. 4B, the objective performance evaluation engine creates a set of sub-tasks and assigns the sub-tasks to individual developers (block 413). Each developer implements the changes required for the sub-task and delivers the code-changes with relevant comments/work item reference into the code repository (e.g., RTC, SVN, GITHUB, etc.) (block 414). Once all the sub-tasks assigned to developers are complete (block 415), the current sprint is released to QA for testing (block 416).

At this point, the objective performance evaluation engine computes the “implementation benchmark ownership” to denote the sole ownership of each implementation delivered (block 417) and composes a matrix of “implementation owner” to “code fragment details.” Code fragment detail is based on the lines range of each artifact modified by the development owner. Based on the proportional contribution to the implementation, the objective performance evaluation engine calculates positive developer impact (block 418). This is a quantification metric (points) to denote the performance of the contribution by comparing “actual” effort to “estimated” effort.

Once the development is complete for a sprint and formally released, QA team will perform the required testing and defects will be raised (block 419). The objective performance evaluation engine then determines whether the defect is assigned to the business team (block 420). At this point, a defect is either assigned to the business team or the development team.

For each defect assigned to business team in block 420, operation returns to FIG. 4A. A business member is assigned to update the design (block 421). Once the design is corrected or updated, the objective performance evaluation engine identifies the source owner of the defect by looking up the “design benchmark ownership” matrix (block 422). The “design benchmark ownership” matrix is updated with the current BA as the additional owner for the design specification areas which are corrected now as part of the design defect (block 423). The objective performance evaluation engine calculates the positive BA impact for the BA who is currently fixing the design (block 424). Then, operation returns to block 411 to calculate negative BA impact for the defect owner.

There are two paths in which negative BA impact is calculated:

Path1: For each design clarification (block 407) raised on top of the design during “Dev” stage, a negative BA impact is computed for the design specification owner (block 411).

Path2: For each design defect identified (block 432, described below) during QA stage, a negative BA impact is computed. However, it is to be noted that the defect will not always be assigned to the same BA who is responsible for the defect. Sometimes it will be assigned to another BA for fixing the design. At this point, objective performance evaluation engine calculates a positive BA impact (block 424) first for the BA who is fixing the design and then calculate the negative BA impact (block 411) for the responsible owner of the defect. For Example: James (BA) created a design element in which a defect was observed during QA stage. A new defect is raised and assigned to another BA Michael. Now Michael receives positive BA impact for fixing the defect, but James receives negative BA impact for introducing the defect.

For each defect assigned to development team (block 420: NO), operation proceeds to FIG. 4C for processing related to the QA team. Turning to FIG. 4C, the objective performance evaluation engine performs QA validation (block 425). For each defect validated by the QA team and assigned to the development team, the objective performance evaluation engine computes QA benchmark ownership and positive QA impact (block 426). Positive QA impact is a factor of project-specific parameters, such as task/defect severity, estimated effort, actual effort, etc. A developer is assigned to fix the code by looking up the implementation benchmark ownership (block 427) and identifying the owner (block 428).

The objective performance evaluation engine determines whether the change is due to a defect earlier raised by a QA (block 429). If the change is due to an earlier raised defect, then the objective performance evaluation engine updates the initial “QA benchmark ownership” matrix (block 430) and computes negative QA impact for the respective QA owner (block 431). This identifies the QA who identified the defect, which was fixed by the developer and computes the positive impact by the QA. Operation ends for this defect. Operation may return to block 425 to validate the next defect.

If the change is not due to a defect earlier raised by QA (block 429: NO) but the defect is part of the version revision history for the design artifact (block 432: YES), the objective performance evaluation engine identifies the source owner of the BA by looking up “design benchmark ownership” matrix (block 433) and calculates negative BA impact for the respective BA owner (block 434). Operation ends for this defect. Operation may return to block 425 to validate the next defect.

If the change is not due to a defect earlier raised by QA (block 429: NO) and the defect is not part of the version revision history for the design artifact (block 432: NO), the objective performance evaluation engine identifies the source owner of the QA by looking up “QA benchmark ownership” matrix (block 435) and calculates negative DEV impact for the respective DEV owner (block 436). The objective performance evaluation engine also calculates the positive developer impact for the developer who is currently fixing the code (block 437). The “implementation benchmark ownership” matrix is updated with the current developer as the additional owner for the implementation benchmark which are corrected now as part of the defect (block 438).

Once the QA testing is complete for a sprint and formally released to UAT/higher environments (block 439), operation proceeds to FIG. 4D for processing related to the UAT team. The objective performance evaluation engine considers valid UAT defects that receives a code fix. A UAT defect is considered valid only if it receives a fix. In reality, some UAT issues can be deemed “not a defect,” “not in scope,” etc. The objective performance evaluation engine does not calculate any negative impact for such defects. Turning to FIG. 4D, for any valid defect raised in block 440, the objective performance evaluation engine identifies the source owner of the QA by looking up “QA benchmark ownership” matrix (block 441) and calculates negative QA impact” for the respective QA owner (block 442). Any defect discovered during the UAT phase after releasing the code implies that the defect escaped the QA test cycle. Therefore, the responsible QA owner should receive a negative impact for this cause. Operation ends for this defect. Operation may return to block 440 to identify the next valid defect.

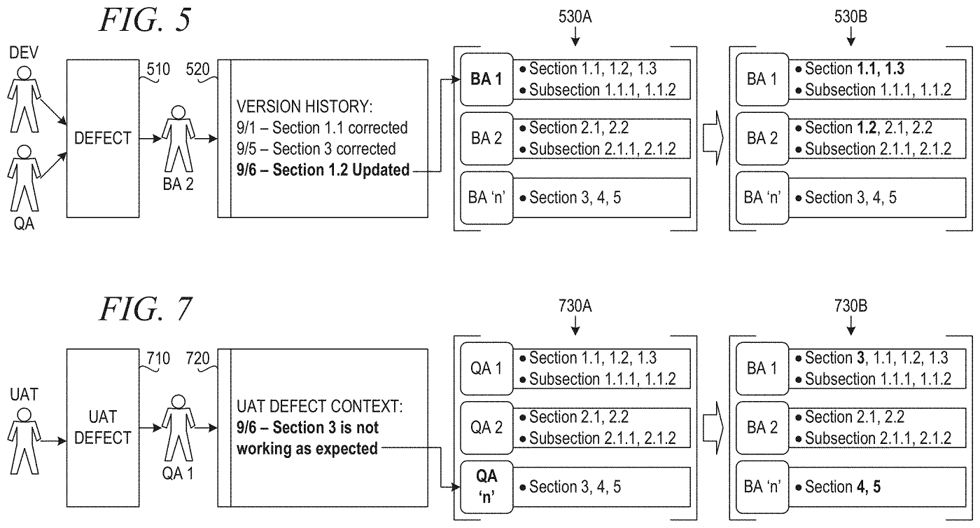

FIG. 5 illustrates identifying a business analyst defect owner in accordance with an illustrative embodiment. The BA receives defects 510 from either the developer team (clarifications) or the QA team (clarifications/gap in requirements). When a defect 510 is assigned to a BA (BA 2 in FIG. 5), the BA fixes the design and updates the version revision history 520 with the defect and design section updated details. The objective performance evaluation engine of the illustrative embodiment takes the impacted sections/sub-sections from the version revision history of the respective design and looks up into the BA benchmark ownership matrix 530A to identify the defect owner. Once the owner is identified, negative BA impact is calculated for the defect owner by the downstream system. The current BA who is fixing the design defect is updated in BA benchmark ownership matrix 530B as the additional owner for the impacted sections which are utilized for subsequent defects raised on the same area.

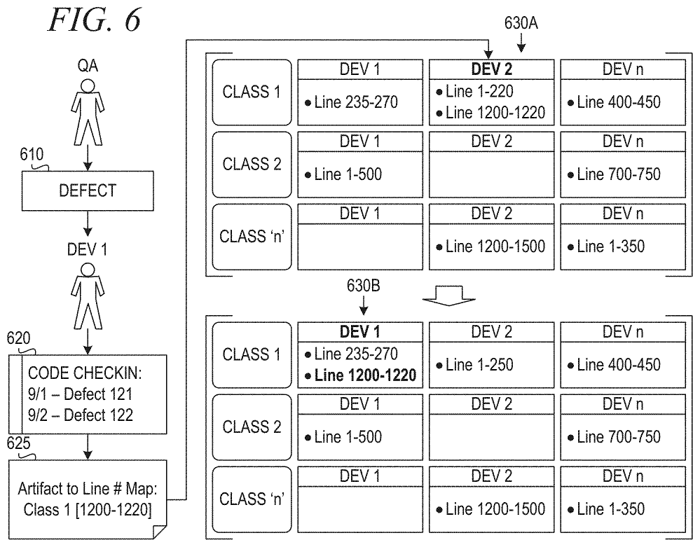

FIG. 6 illustrates identifying a developer defect owner in accordance with an illustrative embodiment. Whenever QA raises a defect 610, the defect is assigned to a developer (DEV 1 in FIG. 6) for a fix. The developer tags the defect while delivering code fix in code check-in 620. The objective performance evaluation engine of the illustrative embodiment compares the existing code in the repository with the modified file to collect the range of line numbers modified as part of the defect for each artifact 625. This detail is further used to look up the developer owner from the implementation benchmark ownership matrix 630A. Once the owner is identified, negative developer impact is calculated for the defect owner by the downstream system. The current developer who is fixing the design defect is updated in implementation benchmark ownership matrix 630B as the additional owner for the impacted lines of code for the given artifact, which is utilized for subsequent defects raised on the same area.

FIG. 7 illustrates identifying a quality assurance defect owner in accordance with an illustrative embodiment. After the code is tested and released to UAT, any defect raised should be mapped to the respective QA member (QA 1 in FIG. 7). When a defect 710 is assigned to a QA, the QA will fix the test cases or retest the defect after defect fix delivery 720. The functional area from where the defect is raised is tracked from the UAT defect itself and the respective owner will be looked up from the QA benchmark ownership matrix 730A. Once the owner is identified, negative QA impact is calculated for the defect owner by the downstream system. The current QA who is testing the defect is updated in QA benchmark ownership matrix 730B as the new owner for the impacted sections, which is utilized for subsequent defects raised on the same area.

A sample calculation of initial benchmark basis points, positive and negative impacts can be as follows. The following insights are extracted on or before developer cutoff: estimated effort and actual effort. The objective performance evaluation engine of the illustrative embodiment calculates the quality metric for initial/positive impact as follows:

PerfBasisPoint=EstEff+(EstEff−ActEff),

where EstEff represents the estimated effort and ActEff represents the actual effort.

After development cutoff, in chronological order each change set is traversed at artifact level to mine the context of the checked-in change. The following insights are extracted:
Defect type: requirement gap/implementation bug;
Severity of the defect;
Estimated Effort;
Actual Effort;
Defect Owner;
Fix owner.

The negative quality impact during defect fixing cycle is calculated as follows:

NegativeQualityImpact=PerfBasisPoint−(EstDefectEff×DefSeverityCoeff

where EstDefectEff represents an estimated effort to correct the defect and DefSeverityCoeff represents a defect severity coefficient.

Defect severity coefficient is a weight assigned to each defect severity based on project needs that can range from 1.0 to 2.0. For example, Blocker=2.0, Critical=1.75, Medium=1.5. For each stake holder, the objective performance evaluation engine of the illustrative embodiment maintains the information of effort and the contribution. The objective performance evaluation engine consolidates all quantified metrics for sub-tasks/defects and arrives at the cumulative contribution percentage as follows:

$$IndividualContribution = ( \frac{Σ TotalBasisPoints}{Σ EstEffort} ) \times 100$$

The individual contribution basis points in descending order provide the ranking of top contributors on the project.

In real-world circumstances, the effort spent in completing a task/defect often does not give a comprehensive picture of the level of complexity or depth of skill involved in solving a work item. The following is an algorithm for calculating the precise degree of positive impact of the work groups under concern in the illustrative embodiments. Normalized effort demand (NED) is introduced to indicate how much bare-metal effort is required to implement a solution, e.g., the time taken to write and execute a field validation test case or the time taken to configure twenty database table rows in XML file format. Note that NED only represents the bare-metal effort. NED does not consider the complications in arriving at such a solution implementation. Also, NED is a system-derived metric that can be overridden/configured manually as needed.

Another quantification metric introduced is absolute effort (AE), which factors in the concealed complexity of a given task/defect beyond the estimated effort. AE makes use of NED to understand the skill involved in arriving at a solution.

As explained above, the main output of a developer is programming artifacts which are added/modified as the solution demands. There are variety of artifact types a developer works with—Java class, classic and specially qualified eXtensive Markup Language (XML), property files, etc. There exists a normalized effort in making changes to such artifacts. For example, in model driven development, adding an attribute through a specialized modeling tool like Rational Software Architect (RSA) tends to take more time than adding an XML element directly to an XML file, and adding an XML element tends to take more time than configuring a simple key-value pair property. The objective performance evaluation engine of the illustrative embodiment differentiates the nominal time taken for different artifacts.

NED comes with two dimensions: NED baseline reference values and NED computed value at work item level. NED baseline reference is a system computed value based on effort pattern in the code repository check-in history. The objective performance evaluation engine builds a catalog of artifacts or artifact sets versus NED based on the identified pattern. This works in coalition with the project maintenance team who can override NED baseline values based on critical relevancy of artifacts to the project.

When a developer delivers a change set and completes a work item, the objective performance evaluation engine calculates NED computed values referring to the baseline reference. This is further used to calculate AE, which factors the complexity associated with the solution provided, as follows:

AE=ActualEffort−ΣArtifactsNED

where ActualEffort represents the actual effort the developer spent to deliver a change set and ArtifactsNED is the NED baseline for each artifact generated by the developer.

Examples of NED baseline derivation for developers are as follows:
Adding 10 rows to a database table that is maintained in conventional or specially qualified XML files: XML NED=1 unit;
Adding 10 drop-down values that are typically configured in XML files: XML NED=0.75 units;
Adding a new business rule to an existing set of business rules typically configured in an XML file format: XML NED=3 units;
Adding a simple user interface validation that is configured in a conventional or specially qualified XML file: XML NED=4 units;
Adding a Java application programming interface (API) to perform simple logic: Java NED=2 units;
Update to existing Java API (<5 lines): Java NED=1 unit.

Another metric for an AE threshold is introduced. This AE threshold AET indicates the saturation level above which the objective performance evaluation engine should consider the work item as a complex or tricky case. If AE>AET, then the objective performance evaluation engine attempts to interpret justification on why the change took time. If the change set combination pattern is familiar based on an earlier check-in, then the developer has taken time for a task/defect that is not complex. If the change set combination pattern is not familiar, then it is the first of its kind, and the objective performance evaluation engine determines that there is a solution involved in identifying the pattern of change (increased complexity). Based on the above, the objective performance evaluation engine concludes on the effort that will directly contribute two calculating positive impact.

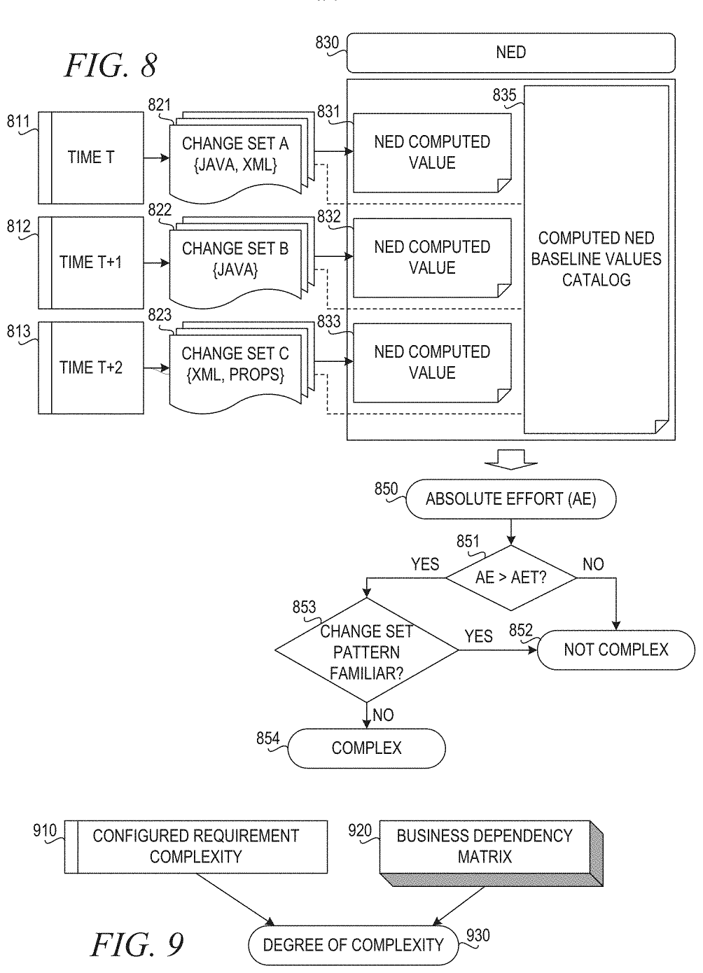

FIG. 8 illustrates derivation of normalized effort demand baseline for developers in accordance with an illustrative embodiment. At time T 811, the developer creates change set A 821. A normalized effort demand component 830 generates NED computed value 831 for change set A 821. At time T+1 812, the developer creates change set B 822. NED component 830 generates NED computed value 832 for change set B 822. At time T+2 813, the developer creates change set C 823. NED component 830 generates NED computed value 833 for change set B 823. NED component 830 creates computed NED baseline values catalog 835.

The objective performance evaluation engine then calculates AE (block 850) based on the computed NED baseline values catalog 835. The objective performance evaluation engine determines whether AE>AET (block 851). If AE is not greater than the AE threshold AET, then the objective performance evaluation engine determines that the changes are not complex (block 852). If AE is greater then AET in block 851, then the objective performance evaluation engine determines whether the change set pattern is familiar (block 853). If the change set pattern is familiar, then the objective performance evaluation engine determines that the changes are not complex (block 852). If the change set pattern is not familiar in block 853, then the objective performance evaluation engine determines that the changes are complex (block 854).

Like developers, AE can be derived for Bas based on their output, namely design updates. Examples of NED baseline derivation for BAs are as follows:
Designing a simple batch to perform a set of business operations in bulk mode: NED=4 units;
Designing a complex batch with complicated business tasks in bulk mode: NED=8 units;
Designing eligibility criteria for a simple new benefit or program: NED=6 units;
Raising a notification or task to concerned target user post business process: NED=1 unit;
Designing audit trail capability for a given business operation: NED=0.5 units;
Adding a new entry to a drop-down: NED=0.2 units.

If AE>AET, then the objective performance evaluation engine attempts to interpret justification on why the change took time.

The objective performance evaluation engine of the illustrative embodiment is designed to mine available design documents in the project and come up with a catalog of a “business dependency matrix.” This indicates how deeply the given design are is intertwined with other functional areas. The proposed system also has a provision to configure “complexity” associated with requirement areas that indicate high level complexity. Based on the insights in the business dependency matrix and the configured requirement area complexity, the objective performance evaluation engine determines the scope of complexity from the BA standpoint. If the complexity scope score is low, this indicates that the task is less complex and, hence, the BA may have taken more time than anticipated.

Like developers and BA, AE can be derived for the QA team based on their test script output and execution intensity. For writing/executing test scripts, process and validation criteria involved in the test case may act as a factor in arriving at systemic NED score, which can be tailored manually by overriding the baseline.

Examples of NED baseline derivation for QA are as follows:
Writing 2 test cases (positive, negative) for testing user interface validation: NED=2 units;
Writing 2 test cases (positive, negative) for testing Web service endpoint validation: NED=4 units (more because precondition is more compared to user interface validation);
Writing 3 test cases (positive, negative, edge) for testing 1 rule of eligibility determination business rule: NED=2 units;
Writing 2 test cases (processing, skipping) for testing batch: NED=2 or 3 units (based on number of batches involved);
Executing 2 test cases of user interface validation: NED=1 unit;
Executing 2 test cases (positive, negative) for testing Web service endpoint validation: NED=3 units (more because precondition is more compared to user interface validation);
Executing 3 test cases (positive, negative, edge) for testing 1 rule of eligibility determination business rule: NED=3 units;
Executing 2 test cases (processing, skipping) for testing batch: NED=4-5 units (based on number of batches involved).

Absolute effort AE is calculated as follows:

AE=ActualEffort−(Σ(NEDWriting)+ΣNEDExecution)

If AE>AET, the objective performance evaluation engine attempts to interpret justification on why the change took time.

The objective performance evaluation engine of the illustrative embodiment is designed to mine available test cases in the project and come up with a catalog of “test area dependency matrix.” This indicates how deeply the given test area is intertwined with other functional areas. The objective performance evaluation engine also has a provision to configure “complexity” associated with requirement areas that indicate high level complexity. Based on the insights on “test area dependency” and configured requirement area complexity, the objective performance evaluation engine determines the scope of complexity from QA standpoint. If the complexity scope score is low, this indicates that the task is less complex and, hence, the QA member may have taken more time than anticipated.

The following is an algorithm to derive a business dependency matrix in accordance with an illustrative embodiment. A list of requirement areas/sub-areas are configured and available as a data dictionary. There exists a column or work sheet name that represents the following:

1. Iterate through each test script/design document;

2. Extract the test area/business area from the designated column/work sheet name;

3. Iterate through each test case/design sub-section;

4. Perform text processing and extract test areas spanned within the test case using Natural Language Understanding;

5. Prepare a matrix with key=requirement area, value=list of dependent requirement area;

6. Repeat steps 1 to 5 every time a new test script is introduced or updated.

FIG. 9 illustrates an algorithm to calculate degree of complexity in accordance with an illustrative embodiment. A complexity weight is assigned for each requirement area identified as part of the business dependency matrix 920. For each version revision delivered by a BA/QA, the objective performance evaluation engine extracts the list of requirement area/sub-area covered by the test case/design document specification, looks up the business dependency matrix and summates, and arrives at the complexity score 930. The degree of complexity is proportional to the calculated complexity score.

As a simplified example, assuming 5 being the most complex and 1 being the least complex: consider the following Business Function vs Requirement Complexity.

BF1=5

→Number of Revisions=2

BF2=3

→Number of Revisions=3

BF3=1

BF4=5

These complexity weights are configured by the project. The degree of complexity can be calculated as follows:

BF1=10

BF2=9

BF3=1

BF4=5

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication-based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising at least one processor and at least one memory, the at least one memory comprising instructions executed by the at least one processor to cause the at least one processor to implement an objective performance evaluation engine, the method comprising:
collecting, by the objective performance evaluation engine, one or more requirements from a customer and developing functional design specifications, wherein the functional design specifications are delivered by the business team as part of a task;
creating, by the objective performance evaluation engine, a set of sub-tasks based on the functional design specifications and assigning the sub-tasks to individual developers, wherein each given developer implements code changes required for a given sub-task and delivers the code changes with comments into a code repository;
generating, by the objective performance evaluation engine, an implementation benchmark ownership data structure for the code changes;
calculating, by the objective performance evaluation engine, positive impact on performance evaluation for the given developer based on a comparison of actual effort to implement the code changes versus estimated effort for the sub-task;
responsive to quality assurance detecting a defect in the code changes, identifying, by the objective performance evaluation engine, an owner of the defect by looking up in the implementation benchmark ownership data structure; and
calculating, by the objective performance evaluation engine, negative impact on performance evaluation for the owner of the defect based on a severity of the defect.

2. The method of claim 1, wherein the implementation benchmark ownership data structure is based on a matrix of implementation owner to code fragment details and wherein the code fragment details.

3. The method of claim 1, wherein calculating positive impact on performance evaluation for the given developer comprises identifying normalized effort demand (NED) values for the code changes.

4. The method of claim 3, wherein calculating positive impact on performance evaluation for the given developer comprises:
calculating an absolute effort value for the code changes based on the actual effort to implement the code changes and the NED values for the code changes; and
comparing the absolute effort value to an absolute effort threshold.

5. The method of claim 4, wherein calculating positive impact on performance evaluation for the given developer further comprises determining that the code changes are not complex responsive to the absolute effort value being less than the absolute effort threshold.

6. The method of claim 4, wherein calculating positive impact on performance evaluation for the given developer comprises:
determining that the code changes are complex responsive to the absolute effort value being greater than the absolute effort threshold and a change set pattern of the code changes being unfamiliar; and
determining that the code changes are not complex responsive to the absolute effort value being greater than the absolute effort threshold and a change set pattern of the code changes being familiar.

7. The method of claim 1, further comprising:
assigning a second developer to fix the defect;
updating the implementation benchmark ownership data structure responsive to assigning the second developer; and
calculating positive impact on performance evaluation for a second developer responsive to the second developer fixing the defect.

8. The method of claim 1, further comprising:
generating, by the objective performance evaluation engine, a design benchmark ownership data structure for the functional design specifications; and
calculating, by the objective performance evaluation engine, positive impact on performance evaluation for a given business analyst within the business team based on a comparison of actual effort to implement the functional design specifications versus estimated effort for the functional design specifications.

9. The method of claim 8, wherein calculating positive impact on performance evaluation for the given business analyst comprises identifying normalized effort demand (NED) values for the functional design specifications.

10. The method of claim 8, further comprising:
responsive to detecting a defect in the functional design specifications, identifying, by the objective performance evaluation engine, an owner of the defect in the functional design specifications by looking up in the design benchmark ownership data structure responsive to quality assurance detecting a defect in the code changes; and
calculating, by the objective performance evaluation engine, negative impact on performance evaluation for the owner of the defect in the functional design specifications.

11. The method of claim 10, further comprising:
assigning a second business analyst to fix the defect in the functional design specifications;
updating the design benchmark ownership data structure responsive to assigning the second business analyst; and
calculating positive impact on performance evaluation for a second business analyst responsive to the second business fixing the defect in the functional design specifications.

12. The method of claim 1, further comprising:
for a given defect validated by a quality assurance (QA) specialist and assigned to a developer, generating, by the objective performance evaluation engine, a QA benchmark ownership data structure; and
calculating, by the objective performance evaluation engine, positive QA impact on performance evaluation for the QA specialist.

13. The method of claim 12, further comprising calculating negative QA impact on performance evaluation for the QA specialist responsive to user acceptance testing detecting a defect not detected by the QA specialist.

14. A computer program product comprising a computer readable storage medium having a computer readable program stored therein, wherein the computer readable program, when executed on a computing device, causes the computing device to implement an objective performance evaluation engine, wherein the computer readable program causes the computing device to:
collect, by the objective performance evaluation engine, one or more requirements from a customer and developing functional design specifications, wherein the functional design specifications are delivered by the business team as part of a task;
create, by the objective performance evaluation engine, a set of sub-tasks based on the functional design specifications and assigning the sub-tasks to individual developers, wherein each given developer implements code changes required for a given sub-task and delivers the code changes with comments into a code repository;
generate, by the objective performance evaluation engine, an implementation benchmark ownership data structure for the code changes;
calculate, by the objective performance evaluation engine, positive impact on performance evaluation for the given developer based on a comparison of actual effort to implement the code changes versus estimated effort for the sub-task;
responsive to quality assurance detecting a defect in the code changes, identify, by the objective performance evaluation engine, an owner of the defect by looking up in the implementation benchmark ownership data structure; and
calculate, by the objective performance evaluation engine, negative impact on performance evaluation for the owner of the defect based on a severity of the defect.

15. The computer program product of claim 14, wherein the computer readable program further causes the computing device to:
assign a second developer to fix the defect;
update the implementation benchmark ownership data structure responsive to assigning the second developer; and
calculate positive impact on performance evaluation for a second developer responsive to the second developer fixing the defect.

16. The computer program product of claim 14, wherein the computer readable program further causes the computing device to:
generate, by the objective performance evaluation engine, a design benchmark ownership data structure for the functional design specifications; and
calculate, by the objective performance evaluation engine, positive impact on performance evaluation for a given business analyst within the business team based on a comparison of actual effort to implement the functional design specifications versus estimated effort for the functional design specifications.

17. The computer program product of claim 16, wherein the computer readable program further causes the computing device to:
responsive to detecting a defect in the functional design specifications, identify, by the objective performance evaluation engine, an owner of the defect in the functional design specifications by looking up in the design benchmark ownership data structure responsive to quality assurance detecting a defect in the code changes; and
calculate, by the objective performance evaluation engine, negative impact on performance evaluation for the owner of the defect in the functional design specifications.

18. The computer program product of claim 17, wherein the computer readable program further causes the computing device to:
assign a second business analyst to fix the defect in the functional design specifications;
update the design benchmark ownership data structure responsive to assigning the second business analyst; and
calculate positive impact on performance evaluation for a second business analyst responsive to the second business fixing the defect in the functional design specifications.

19. The computer program product of claim 14, wherein the computer readable program further causes the computing device to:
for a given defect validated by a quality assurance (QA) specialist and assigned to a developer, generate, by the objective performance evaluation engine, a QA benchmark ownership data structure; and
calculate, by the objective performance evaluation engine, positive QA impact on performance evaluation for the QA specialist.

20. An apparatus comprising:
a processor; and
a memory coupled to the processor, wherein the memory comprises instructions which, when executed by the processor, cause the processor to implement an objective performance evaluation engine, wherein the instructions cause the processor to:
collect, by the objective performance evaluation engine, one or more requirements from a customer and developing functional design specifications, wherein the functional design specifications are delivered by the business team as part of a task;
create, by the objective performance evaluation engine, a set of sub-tasks based on the functional design specifications and assigning the sub-tasks to individual developers, wherein each given developer implements code changes required for a given sub-task and delivers the code changes with comments into a code repository;
generate, by the objective performance evaluation engine, an implementation benchmark ownership data structure for the code changes;
calculate, by the objective performance evaluation engine, positive impact on performance evaluation for the given developer based on a comparison of actual effort to implement the code changes versus estimated effort for the sub-task;
responsive to quality assurance detecting a defect in the code changes, identify, by the objective performance evaluation engine, an owner of the defect by looking up in the implementation benchmark ownership data structure; and
calculate, by the objective performance evaluation engine, negative impact on performance evaluation for the owner of the defect based on a severity of the defect.
